(19) United States
(12) Patent Application Publication
(10) Pub. No.: US 2026/0170653 A1
(43) Pub. Date: Jun. 18, 2026

(54) MULTI-STAGE MACHINE VISION TECHNIQUE FOR ANALYZING IMAGES OF OBJECTS

(71) Applicant: Applied Materials, Inc., Santa Clara, CA (US)

(72) Inventors: Purnendu Mishra, Ranchi (IN); Gursewak Singh, Bangalore (IN); Shubham Mathur, Jaipur (IN); Rajiv Kumar, Gaya (IN); Yash Chhabra, Bangalore (IN); Hsiang-Ying Yu, Sunnyvale, CA (US); Kedar Uday Palsule, San Jose, CA (US)

(73) Assignee: Applied Materials, Inc., Santa Clara, CA (US)

(21) Appl. No.: 18/979,029

(22) Filed: Dec. 12, 2024

(51) Int. Cl. G06T 7/11; G06T 5/70; G06T 7/136; G06T 7/194; G06T 7/90

(52) U.S. Cl. CPC G06T 7/11; G06T 5/70; G06T 7/136; G06T 7/194; G06T 7/90; G06T 2207/20081; G06T 2207/20084

(57) ABSTRACT

Disclosed herein is a multi-stage vision technique for analyzing images of objects. The techniques include accessing an image of a plurality of objects and pre-processing the image to detect a region of interest in the image, the region of interest corresponding to a section of the image that includes the plurality of objects. Once the image is pre-processed, a machine learning model is applied to determine a first estimate of a count of the plurality of objects. From there, a density estimation algorithm is applied to the image to determine an object density of the region of interest. Next, the first estimate of the count of the plurality of objects is adjusted based on the object density of the region of interest to obtain a final count of the plurality of objects. The techniques further include outputting the final count on a display.

### FIELD OF INVENTION

The present application relates generally to machine vision techniques. More specifically, the present application relates to a multi-stage machine vision technique for analyzing images of objects.

### BACKGROUND

Screws, nuts, bolts and other small objects make up a significant amount of inventory for various enterprises. Counting these objects, referred to as “bin-bulk,” is time-consuming and prone to human counting error. Most of the current counting systems either use moving objects (e.g., a conveyor belt), are not mobile, or cannot handle multiple types of objects. Moreover, some of the existing systems for counting these objects are either inaccurate, slow, not easy to use, require increased servicing, have high latency, are not scalable, or are not cost effective.

For example, some current devices are fixed in position and include a conveyor belt with a camera capturing images of objects as they pass over the conveyor. However, because of the machinery required to operate the conveyor, the overall machine is too large to move around a warehouse or other facility.

Accordingly, there is a need to provide an improved system that addresses the above deficiencies.

### BRIEF SUMMARY

In one aspect, disclosed herein is a computer implemented method for a multi-stage machine vision analysis of images of objects. In some embodiments, the method includes accessing an image of a plurality of objects. In some embodiments, the method includes pre-processing the image to detect a region of interest in the image, the region of interest corresponding to a section of the image that includes the plurality of objects. In some embodiments, the method includes applying a machine learning model to the pre-processed image to determine a first estimate of a count of the plurality of objects. In some embodiments, the method includes applying a density estimation algorithm to determine an object density of the region of interest. In some embodiments, the method includes adjusting the count of the plurality of objects based on the object density of the region of interest to obtain a final count of the plurality of objects. In some embodiments, the method includes outputting the final count on a display.

In another aspect, a system is provided, the system comprising a processing circuit; and a memory for storing executable instructions, which when executed by the processing circuit causes the processing circuit to perform various operations. In some embodiments, the processing circuit is caused to access an image of a plurality of objects. In some embodiments, the processing circuit is caused to pre-process the image to detect a region of interest in the image, the region of interest corresponding to a section of the image that includes the plurality of objects. In some embodiments, the processing circuit is caused to apply a machine learning model to the pre-processed image to determine a first estimate of a count of the plurality of objects. In some embodiments, the processing circuit is caused to apply a density estimation algorithm to determine an object density of the region of interest. In some embodiments, the processing circuit is caused to adjust the count of the plurality of objects based on the object density of the region of interest to obtain a final count of the plurality of objects. And in some embodiments, the processing circuit is caused to output the final count on a display.

In another aspect, a non-transitory computer-readable medium is provided, the non-transitory computer-readable medium having executable instructions stored thereon, which when executed by a processing circuit, cause the processing circuit to perform various operations. In some embodiments, the processing circuit is caused to access an image of a plurality of objects. In some embodiments, the processing circuit is caused to pre-process the image to detect a region of interest in the image, the region of interest corresponding to a section of the image that includes the plurality of objects. In some embodiments, the processing circuit is caused to apply a machine learning model to the pre-processed image to determine a first estimate of a count of the plurality of objects. In some embodiments, the processing circuit is caused to apply a density estimation algorithm to determine an object density of the region of interest. In some embodiments, the processing circuit is caused to adjust the count of the plurality of objects based on the object density of the region of interest to obtain a final count of the plurality of objects. And in some embodiments, the processing circuit is caused to output the final count on a display.

Non-transitory computer program products (i.e., physically embodied computer program products) are also described that store instructions, which, when executed by one or more data processors (i.e., processing circuit) of one or more computing systems, cause at least one data processor to perform operations herein. Similarly, computer systems are also described, which may include one or more data processors and memory coupled to the one or more data processors. The memory may temporarily or permanently store instructions that cause at least one processor to perform one or more of the operations described herein. In addition, methods can be implemented by one or more data processors, which are either within a single computing system or distributed among two or more computing systems. Such computing systems can be connected and can exchange data and/or commands or other instructions or the like via one or more connections, including but not limited to a connection over a network (e.g., the Internet, a wireless wide area network, a local area network, a wide area network, a wired network, or the like), via a direct connection between one or more of the multiple computing systems, etc.

The details of one or more variations of the subject matter described herein are set forth in the accompanying drawings and the description below. Other features and advantages of the subject matter described herein will be apparent from the description and drawings, and from the claims.

### BRIEF DESCRIPTION OF THE SEVERAL VIEWS OF THE DRAWINGS

Provided below is a brief description of the several views of the drawings which illustrate various aspects of some embodiments of the present disclosure. The various drawings are described in more detail in the Detailed Description that follows. To easily identify the discussion of any particular element or act, the most significant digit or digits in a reference number refer to the figure number in which that element is first introduced.

It should be understood that the drawings are not necessarily to scale and that the disclosed embodiments are sometimes illustrated diagrammatically and in partial views. In certain instances, details which are not necessary for an understanding of the disclosed methods and devices or which render other details difficult to perceive may have been omitted. It should be further understood that this disclosure is not limited to the particular embodiments illustrated herein. In the drawings, like numbers refer to like elements throughout unless otherwise noted.

FIG. 1 illustrates a block diagram of an image capture environment in accordance with one embodiment.

FIG. 2A illustrates a network diagram of an image processing system in accordance with one embodiment.

FIG. 2B illustrates a block diagram of an image processing server in accordance with one embodiment.

FIG. 3 illustrates a process flow diagram in accordance with one embodiment.

FIG. 4 illustrates a process flow diagram in accordance with one embodiment.

FIG. 5A illustrates a process flow diagram in accordance with one embodiment.

FIG. 5B illustrates a process flow diagram in accordance with one embodiment.

FIG. 5C illustrates a process flow diagram in accordance with one embodiment.

FIG. 5D illustrates a process flow diagram in accordance with one embodiment.

FIG. 5E illustrates a process flow diagram in accordance with one embodiment.

FIG. 6 illustrates density regression flow diagram in accordance with one embodiment.

FIG. 7A illustrates object scatter in an image in accordance with one embodiment.

FIG. 7B illustrates another image capture environment in accordance with one embodiment.

FIG. 8 illustrates a flow diagram of an example method in accordance with one embodiment.

### DETAILED DESCRIPTION

Provided herein are systems, methods, and computer readable mediums for a multi-stage machine vision technique for capturing and analyzing images of objects. Namely, the disclosed subject matter provides a technical solution to the above technical problems involving analyzing images and counting objects within the images. The proposed techniques provided in the present application improve existing imaging technologies and counting systems. The techniques described herein include improvements to imaging technologies and counting systems by first pre-processing the image to reduce its size, remove noise, and detect a region of interest (ROI) in the image (e.g., a region of the image where the objects are located). Next, the disclosed techniques improve upon existing systems by applying a machine learning algorithm trained using public data to determine bounding boxes to assign to each detected object instance. The machine learning model is a deep learning model trained on a public dataset that includes a faster inference speed, and the model is customized for objects counting. The number of bounding boxes assigned to the object instances in the image represents an estimated count of the number of objects in the image. This can be referred to as a first stage of the image analysis process described herein.

The present application discloses further improvements to imaging technologies and counting systems by applying a density estimation algorithm to the image to modify the estimated count of the number of objects in the image. Applying the density estimation algorithm provides another estimate of the number of objects in the image, and the initial estimate that was determined can be modified to be somewhere between the estimate from the density estimation and the estimate determined using the bounding boxes. Applying the density estimation algorithm can be referred to as a second stage of the image analysis process described herein.

These techniques provide a practical application because they combine machine learning techniques, density estimation algorithms, and other features described herein to provide an improvement over existing technologies. Improvements provided by the system include a counting estimation system that is more accurate, more mobile, faster, safer, easy to use, requires less servicing, is more device agnostic, operates at lower latency, is more scalable, and is more cost effective than existing systems. The disclosed techniques also provide an improvement to the functioning of a computer. More specifically, techniques described herein provide an improvement to the functioning of a computer performing counting of objects because the combination of the machine learning model and density estimation algorithm provide a lower latency count estimate of the objects. The lower latency is provided by the improved and more efficient combination of the machine learning models and the density estimation algorithm. This improves processing time and memory utilization that results in the lower latency of the image analysis.

Techniques described herein cannot practically be performed in the human mind. They require complex calculations and determinations, including use of machine learning models, determining location of objects based on pixel level analysis in the pictures to identify regions of interest, bounding boxes, and the density estimation of the objects in the image.

As described below, the systems and techniques described herein provide an object counting estimation having multiple stages. Initially, it should be noted that the techniques described herein may or may not include actual capturing of the images. For instance, in some embodiments, the system may access an image already captured in advance and analyze the image to determine the object count. In other embodiments, the system includes an image capturing device and the image of a tray of objects is captured and sent to one or more servers for analysis. The features and techniques described below provide further detail on how the image is analyzed to determine an estimated count of the objects within the image.

With general reference to notations and nomenclature used herein, one or more portions of the detailed description which follows may be presented in terms of program procedures executed on a computer or network of computers. These procedural descriptions and representations are used by those skilled in the art to most effectively convey the substances of their work to others skilled in the art. A procedure is here, and generally, conceived to be a self-consistent sequence of operations leading to a desired result. These operations are those requiring physical manipulations of physical quantities. Usually, though not necessarily, these quantities take the form of electrical, magnetic, or optical signals capable of being stored, transferred, combined, compared, and otherwise manipulated. It proves convenient at times, principally for reasons of common usage, to refer to these signals as bits, values, elements, symbols, characters, terms, numbers, or the like. It should be noted, however, that all of these and similar terms are to be associated with the appropriate physical quantities and are merely convenient labels applied to those quantities.

Useful machines for performing operations of various embodiments include digital computers as selectively activated or configured by a computer program stored within that is written in accordance with the teachings herein, and/or include apparatus specially constructed for the required purpose or a digital computer. Various embodiments also relate to apparatus or systems for performing these operations. These apparatuses may be specially constructed for the required purpose. The required structure for a variety of these machines will be apparent from the description given.

As used herein, the phrases “caused to” and “configured to” may be used interchangeably when referring to actions performed by a processor or processing circuit. Instructions or program code executed by the processor or processing circuit causes or configures the processor or processing circuit to perform various operations described herein.

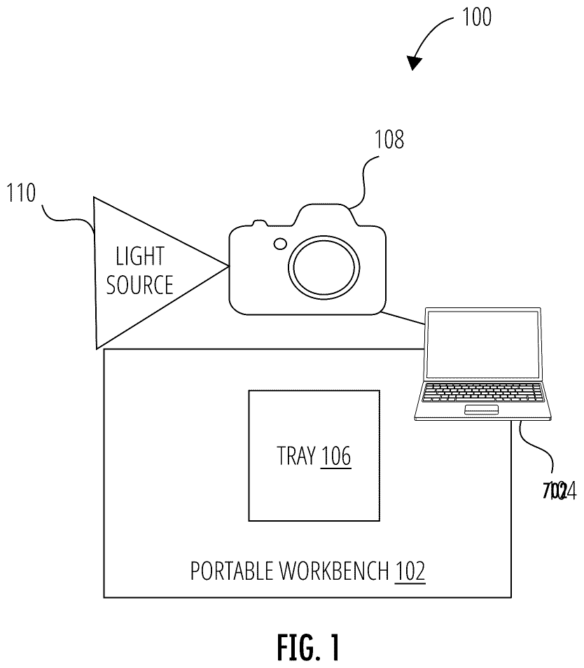

FIG. 1 illustrates an example image capture environment 100 for capturing one or more images to be processed using the systems and methods described herein. FIG. 1 illustrates one example in which images are captured, however, the system and techniques described herein that follow can be implemented using any image captured in any suitable way. As such, the present disclosure is not limited in any way by the image capture environment 100.

In some embodiments, the image capture environment 100 includes a mobile or portable workbench 102 that is mobile and can be moved around in any suitable space. For example, the portable workbench 102 can be located in a warehouse or any other location and made mobile such that it can be moved around the warehouse or other location. In some embodiments, the portable workbench 102 includes a workstation 104. The workstation 104 can be any suitable computing device that includes a processing circuit, a display, a user interface (e.g., mouse, keyboard, touchscreen, bar code reader, scanner, radio frequency identification (RFID) reader, etc.), a printer, or any other suitable input or output device for the workstation 104. For example, the workstation 104 can be a desktop computer, a personal computer, a laptop, a server connected to a monitor, a thin client, a thick client, a mobile device, a tablet computer, an iPad®, or any other suitable computing device.

The portable workbench 102 can include one or more trays 106. The tray 106 is used to hold the one or more objects for taking a picture thereof. For example, the tray 106 can be any tray, bowl, plate, platter, cup, or any other suitable receptacle for holding one or more objects. In some embodiments, a color of the surface of the tray 106 where the objects are located thereon can be selected to be any suitable color that is complimentary to the silver color of metallic objects. For example, the background color of the tray 106 can be light blue, light purple, light green, or any other suitable color that is complimentary to metallic objects. In some embodiments, the background color is chosen to provide a high contrast between the objects and the background. In some embodiments, the background color is a matte color that is complimentary to a color of the plurality of objects.

In some other embodiments, the objects or parts may be black or any other suitable color. In such cases, the color of the tray may be selected to be complimentary to the color of the objects. For example, if the objects are black, the color of the tray, and thereby the background color of the image can be selected to be white.

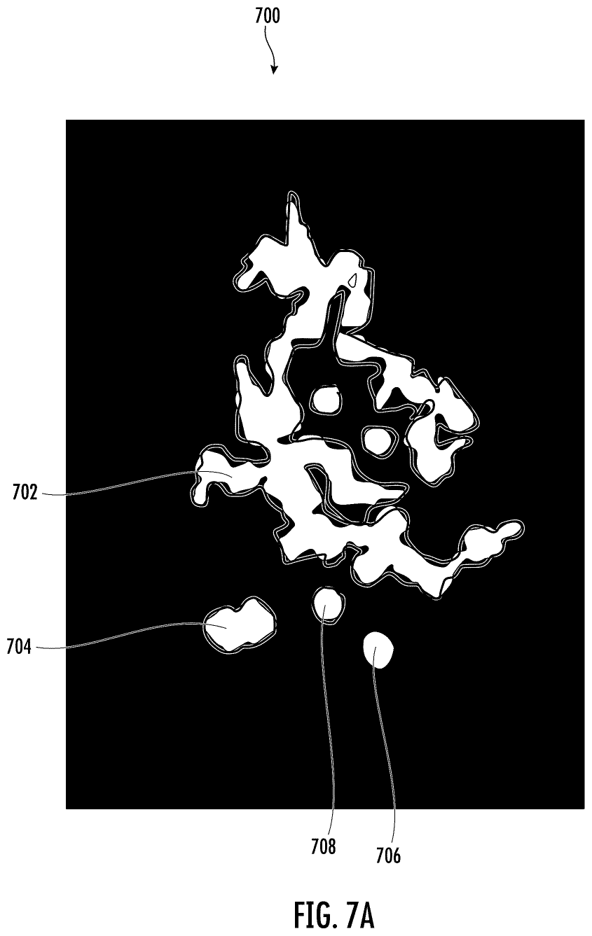

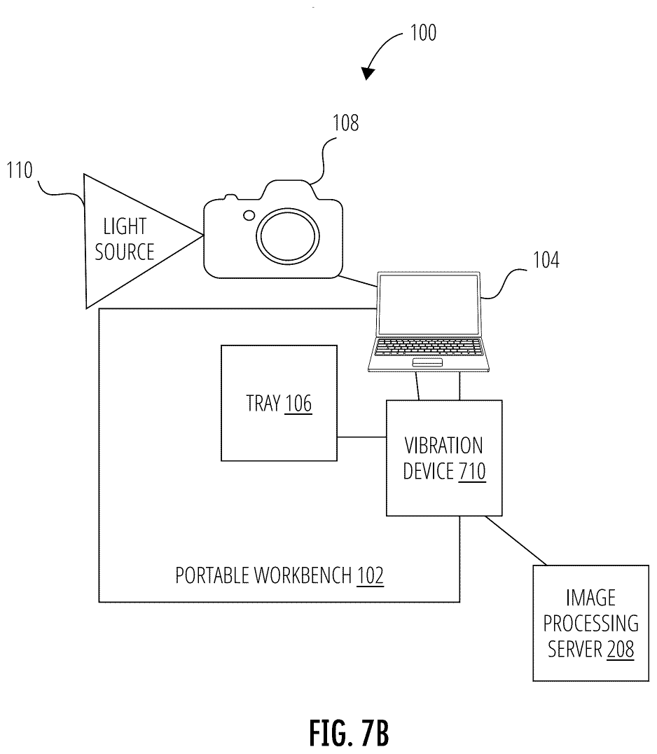

The tray 106 can be made of any suitable material. For example, the tray 106 can be made from plastic, metal, cardboard, wood, or any other suitable material. For example, the tray 106 can include a 3-dimensional (3D) printed tray made from plastic and dimensioned to accommodate a large number and variety of objects with different sizes and aspect ratio with separation between the objects such that there is no overlap of objects. The surface of the tray 106 that acts as a background for the image can be textured or non-textured. As shown in FIG. 7B, the tray 106 can include a vibration device 710. The operation of the vibration device 710 is described in greater detail in FIG. 7B, but the purpose of the vibration device 710 is to create further separation among the objects if they are not separated sufficiently. In some embodiments, the tray 106 can be positioned on a non-slip mat.

In some embodiments, the portable workbench 102 includes an image capture device 108 (e.g., attached to the portable workbench 102). In some embodiments, the image capture device 108 is a camera, a webcam, a high-resolution camera, a sensor, or any other image capturing device. The image capture device 108 is configured to capture one or more images of the objects in the tray 106. In some embodiments, the portable workbench 102 further includes a light source 110 (e.g., attached to the portable workbench 102). The light source 110 can include any suitable light source such as a lamp, camera flash bulb, flashlight, photography light, ring light, or any other suitable light source 110 to provide light to the tray 106 during image capture. The light source 110 can be fixed on the portable workbench 102 and directed at the tray 106 to mitigate variations arising due to environmental light and to maintain light uniformity across the tray 106.

Though not shown in FIG. 1, in some embodiments, the portable workbench 102 includes a barcode scanner to capture object information. For example, the objects may first come in a box with a barcode thereon. The barcode can include details about the dimensions of the object, type of object, part number, description of the object, etc. These details can be captured by scanning the barcode. The barcode scanner can be an input device into the workstation 104 to provide information about the objects in the tray 106 to the workstation 104.

The parts or objects can be positioned in the tray 106, light source 110 illuminated, and the image captured by the image capture device 108. Once the image is captured, the image can be sent from the workstation 104 to a machine learning server as described herein below for processing. Alternatively, the image can be captured and then stored in a storage device (not shown), such as the hard drive or other memory of the workstation 104, or a datastore in network communication with the workstation 104 or the image capture device 108.

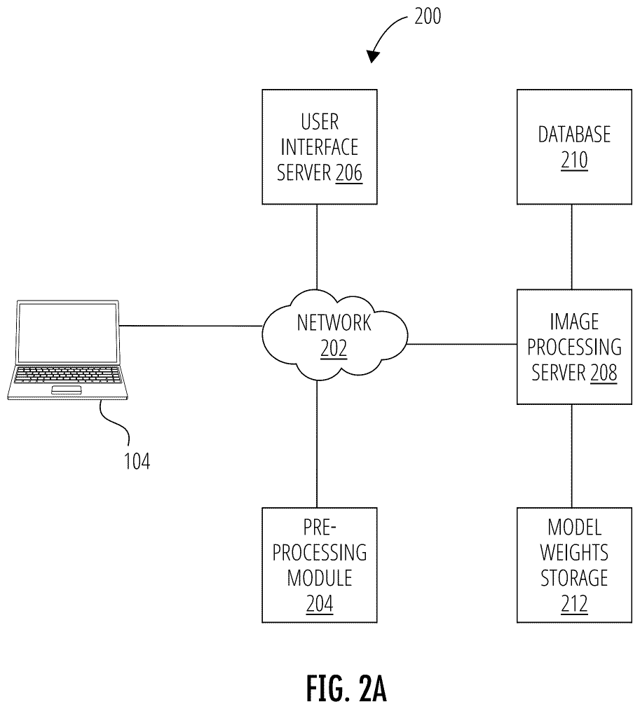

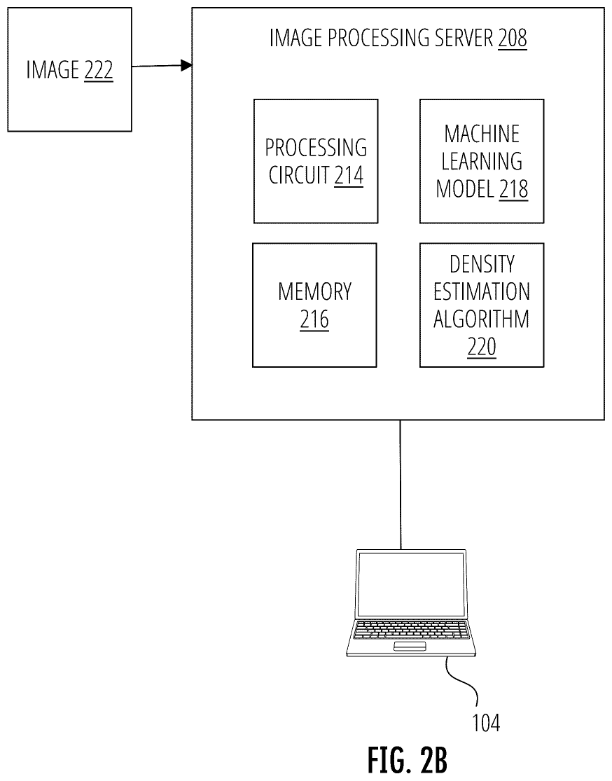

FIG. 2A is a network diagram illustrating an example image processing system 200 for processing an image of parts or objects, such as the images that may be captured at the portable workbench 102 described in FIG. 1. In some embodiments, the image is captured by the image capture device 108 of FIG. 1 or the image may be captured by any suitable device. As described above, the image to be processed can be sent directly to the image processing system 200 right after the image has been captured, or the image can be stored in a data storage device and the image processing system 200 simply accesses the image after it has been stored. In either event, whether the image is received from the workstation 104 or the image capture device 108, directly after the image has been captured, or if the image is stored in a storage device (not shown) and accessed by the image processing system 200, the steps of processing the image does not change.

In some embodiments, the image processing system 200 includes the workstation 104 described above or a datastore and a network 202 for connecting the workstation 104 or datastore to various other devices. For example, the image processing system 200 may include a pre-processing module 204, a user interface server 206, and an image processing server 208. In some embodiments the pre-processing module 204 and the user interface server 206 can be operated or executed on the image processing server 208. In some other embodiments, the pre-processing module 204 and the user interface server 206 are executed on different computing devices. Alternatively, the pre-processing module 204 can be implemented on the workstation 104 and the user interface server 206 can operate an application that communicates with a corresponding front end application user interface on the workstation 104.

The network 202 can include any suitable network such as any wired or wireless network that allows data to be communicated between the various computing systems or devices that make up the image processing system 200. For example, the network 202 can include a local area network (LAN), wide area network (WAN), data center network, wireless communications network, the Internet, or any combination thereof. The network 202 allows the image data and various other communications to be transmitted to and from the various devices and systems depicted in the image processing system 200.

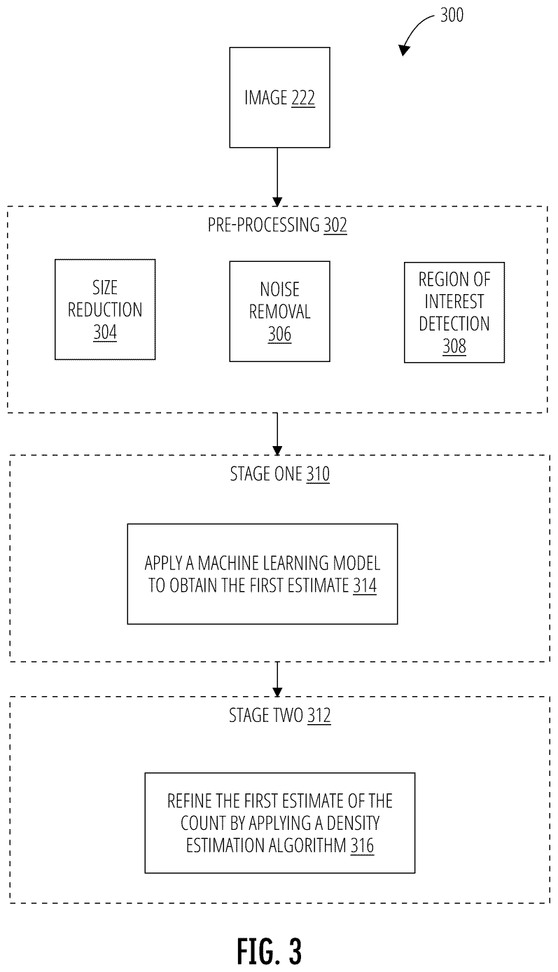

In some embodiments, the pre-processing module 204 is a software or hardware module (or combination thereof), that is configured to receive or access the image data from the workstation 104 or datastore and pre-process the image before it is sent to the image processing server 208 for further processing. The pre-processing module 204 is configured to prepare the image for processing by the image processing server 208. FIG. 3 provides a more detailed discussion of the pre-processing of the image.

The user interface server 206 may include a server or other computing device that operates with the workstation 104 as a back-end to front-end pair, to provide a user interface on the workstation 104 to display some of the features of the images described herein. For example, the workstation 104 may execute a computer application thereon that displays a user interface (e.g., front end) that is managed by the user interface server 206 (e.g., back end). The user interface server 206 can cause the workstation 104 to display the image on the user interface and display the user interface on the display of the workstation 104. The user interface can display the image captured of the objects or parts within the tray 106. The user interface server 206 can communicate with the image processing server 208 to determine updates to the image or different manipulations thereon. Then, the user interface server 206 can cause these updates or manipulations to be displayed on the image that is shown to the user on the workstation 104. The user interface server 206 can also cause a final count of the objects to be displayed to the user on the workstation 104. The final count is the final determined count of the number of objects in the image (e.g., on the tray 106 in the image).

The user interface server 206 can cause a real-time video or image feed of the tray 106 on the portable workbench 102 to be displayed on the display of the workstation 104, and then show the count of the number of objects after the count has been determined. Alternatively, the user interface server 206 can cause a still image that was captured previously to be displayed on the display of the workstation 104.

The image processing system 200 can also include the image processing server 208 which processes the image to determine the number of parts or objects in the image. The image processing server 208 can include any suitable computing device such as a computer, server, cloud server, datacenter server, or any other device capable of inspecting ana analyzing images at a pixel level, executing a machine learning algorithm or model, a density estimation algorithm, and other software functions described herein. The image processing server 208 is in communication with a database 210 and model weights storage 212 that store various data to implement the machine learning model, density estimation algorithm, and other operations described herein. For example, the database 210 can include different machine learning models based on the type of object in the image. The database 210 can further include various images and other data used to train the machine learning model. The model weights storage 212 includes model weights to weight various parts of the deep learning model, as described in further detail below. The model weights refer to the value of filter parameters optimized during the model training process. FIG. 2B provides more detail about the image processing server 208.

FIG. 2B illustrates an example configuration of the image processing server 208. In some embodiments, the image processing server 208 includes a processing circuit 214 and a memory 216 for storing executable instructions, which when executed by the processing circuit 214 causes the processing circuit 214 to perform various operations described herein. The image processing server 208 further includes a machine learning model 218 that has been trained using public training data to detect or identify objects or parts in an image. The image processing server 208 further includes a density estimation algorithm 220 configured to determine an object or part density of parts or objects in an image. Operations of these models and algorithms are described in more detail below.

In some embodiments, the image processing server 208 is configured to receive or access an image 222 of a plurality of objects. The image of the plurality of objects can include an image of a plurality of parts or objects in a tray 106, as described above. In other embodiments, the image 222 of the plurality of objects is not in a tray, but instead the image 222 includes just the objects with a background. The image 222 of the plurality of objects can be an image of all the same type of object or can be one or more different types of objects. In some embodiments, the image 222 only includes a single object and only the single object is detected. In some other embodiments, the image includes multiple different types of objects, in which case the processing circuit 214 is configured to perform object classification to classify each of the different objects and then detect the number of each type of object.

In some embodiments, the processing circuit 214 is caused to pre-process the image 222 to detect a region of interest in the image 222, the region of interest corresponding to a section of the image that includes the plurality of objects. The pre-processing may also be performed by another device such as the workstation 104 and then the pre-processed image is passed to the image processing server 208 for additional processing as described below. Pre-processing steps are described in further detail in FIG. 3 below.

Once the image has been pre-processed, the processing circuit 214 is further caused to apply a machine learning model 218 to the pre-processed image to determine a first estimate of a count of the plurality of objects. Application of the machine learning model 218 is described in more detail below. Next, after the first estimate of the count of the plurality of objects has been determined, the processing circuit 214 is caused to apply a density estimation algorithm 220 to determine an object density of the region of interest. The density estimation algorithm 220 is described in further detail below, but in summary, the density estimation algorithm 220 determines a total density of the objects in the image and identifies a single object and determines the density of the single object. Then the density estimation algorithm 220 divides the total density by the single object density to determine an object density of the region of interest. The processing circuit 214 is then caused to adjust the count of the plurality of objects based on the object density of the region of interest to obtain a final count of the plurality of objects. Then the processing circuit 214 is caused to output the final count on a display, such as on the display of the workstation 104. For example, the image processing server 208 can send the final count directly to the workstation 104 for display. In some other embodiments, the image processing server 208 can send the final count to the user interface server 206 (e.g., back end of the application) which can then send a signal to the workstation 104 for the application operating on the workstation 104 (e.g., front end of the application) to display the final count of the objects in the tray 106. The user interface server 206 sends the signal to the workstation 104 to update what is displayed on the user interface of the application to display the final count of the objects in the tray 106.

FIG. 3 illustrates an example image processing flow 300 and provides more detail on how the image is pre-processed. Once the image 222 has been captured, either the image processing server 208 or the workstation 104 will receive the image 222. In some embodiments, the workstation 104 or the image processing server 208 will pre-process the image 222. In some embodiments, pre-processing 302 the image can include size reduction 304, noise removal 306, and region of interest detection 308 of the image 222.

In some embodiments, the image 222 may be captured in 720P, 1080P, 2K, 4K, 8K or some other high resolution. In some cases, it might be desired to reduce a size of the image 222. Reducing the size of the image may involve resizing or reducing the size of the high resolution image so that it can be processed efficiently by the image processing server 208. As such, in some embodiments, the processing circuit 214 is caused to reduce a size of the image during pre-processing. In some other embodiments, the workstation 104 performs the size reduction. Any suitable technique, now known or hereafter discovered, can be used to reduce the size of the image. For example, in some embodiments, a “bicubic interpolation” method is used to reduce the size of the image. In some embodiments, the smallest image size is 1024 pixels in an aspect ratio of 16:9. In some embodiments, the user interface operated by the user interface server 206 and the front end workstation 104, provides an option to set the image size between 1024 pixels and 7680 pixels, based on the image capturing setup, the bandwidth or throughput constraints of network 202, and observed object counting accuracy. The image can be reduced by any amount to any suitable size.

In some embodiments, the image of the plurality of parts or objects can include noise. Image noise is random variation of brightness or color information in images, and is usually an aspect of electronic noise. It can be introduced by the image sensor and circuitry of a scanner or digital camera. Image noise can also originate in film grain and in the unavoidable shot noise of an ideal photon detector. In many cases, to provide the processing circuit 214 a more precise image of the one or more objects, it might be desirable to reduce noise in the image 222. There are various noise reduction techniques known to those having ordinary skill in the art. In some embodiments, one or more noise reduction techniques, such as any technique now know or later discovered, can be used to reduce the noise of the image 222. For example, in some embodiments, the processing circuit 214 is configured to apply a noise removal algorithm to the image 222. The noise removal 306 can be performed before or after the size of the image 222 is altered, or simultaneously therewith.

Next, once the image 222 has been reduced and noise removal 306 has occurred, the processing circuit 214 is caused to perform region of interest detection 308. In some embodiments, detecting a region of interest in the image 222 includes inspecting pixels of the image 222 to determine which pixels of the image 222 correspond to an object of the plurality of objects, and which pixels correspond to a background of the image. Next, detecting the region of interest includes determining, based on inspection of the pixels, a perimeter of a location of the image 222 within which the plurality of objects are located.

Next, detecting the region of interest includes digitally drawing a border along the perimeter of the location, the border corresponding to the region of interest. In some embodiments, the border is a digital border whose location around the plurality of objects is maintained by the processing circuit 214 in a database or in memory 216. The border can be drawn by the processing circuit 214 and shown on a display of the workstation 104 or the border can be determined by the workstation 104 and displayed thereon. In any event, the region of interest and the pixels of the image that correspond to the border of the region of interest are identified by the processing circuit 214 of the image processing server 208 or by the workstation 104. If the region of interest is determined by the workstation 104, the pixels that make up the region of interest are sent to the image processing server 208 for further stages in the analysis.

In some embodiments, the image processing flow 300 further includes stage one 310, whereby the processing circuit 214 of the image processing server 208 is configured to apply a machine learning model to obtain the first estimate 314 of the count of the plurality of objects. Next, after the first estimate of the count is obtained, the image is processed in stage two 312 at the image processing server 208. In some embodiments, the processing circuit 214 is caused to refine the first estimate of the count by applying a density estimation algorithm 316. There are various options for applying the density algorithm as described below. Once the count is refined, this determines the final count, and the final count is sent from the image processing server 208 to the workstation 104 or to the user interface server 206 for displaying the final count on the workstation 104.

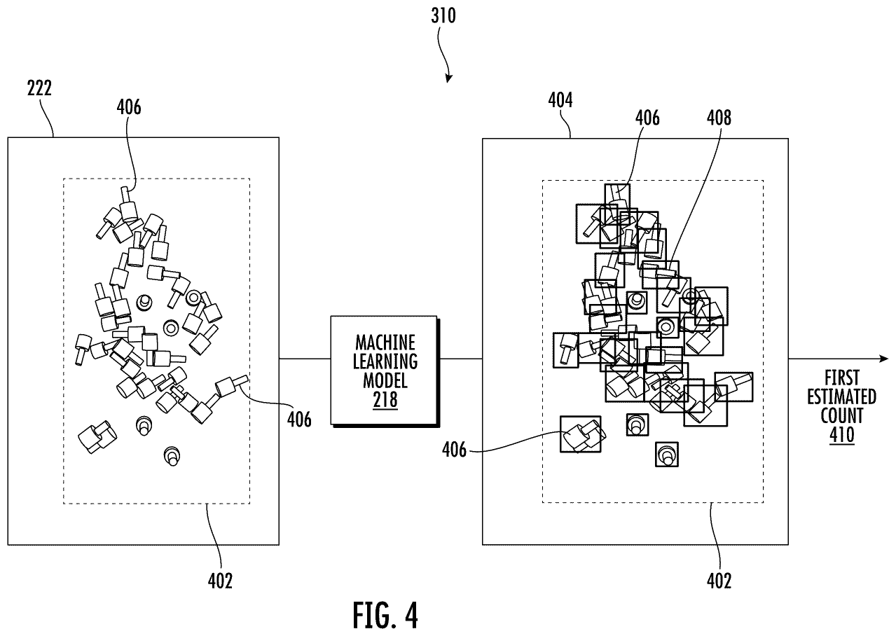

FIG. 4 illustrates an example implementation of stage one 310 of the multi-stage vision technique for analyzing images of objects according to some embodiments of the present disclosure. For example, the image 222, which has been pre-processed with the size reduced, the noise removed, and the region of interest 402 identified, can be sent to or accessed by the image processing server 208. The processing circuit 214 can then apply the machine learning model 218 to the image 222. In some embodiments, the machine learning model 218 is a trained deep learning model, trained on a public dataset of various objects, and the processing circuit 214 is further caused to use the trained deep learning model to perform various operations. These operations include the processing circuit 214 using the machine learning model 218 to identify candidate individual instances of an object 406 from the plurality of objects 406. In some embodiments, the machine learning model 218 can be agnostic as to the type of object in the image. In some other embodiments, a machine learning model 218 can be developed per type of object. For example, when screws are being counted, a machine learning model 218 specific to screws can be used, or nuts, etc. In one example, the RetinaNet deep learning model can be used as the machine learning model 218.

In some embodiments, the machine learning model 218 is provided with a plurality of threshold parameters and hyperparameters to help identify individual instances of the objects in the image 222. At the time of detecting the objects in the captured image, the detection accuracy is a function of two threshold values namely IoU (intersection over union) threshold and confidence threshold. The IoU threshold (e.g., between 0 and 1) helps select the best possible representation of a detected object out of many proposals generated by the model. The confidence threshold (e.g., between 0 and 1) helps determine the prediction score of a detected object. If the score of an object is above the user defined confidence threshold, then it is considered as a valid object. Otherwise, it is considered as background. The combination of IoU and confidence threshold helps achieve balance between precision and recall values. That is, balance between false positive and false negative detection (both should be lower of best performance of the model). Using a Grid Search technique, the best combination of IoU and confidence threshold is determined.

The machine learning model 218 will then analyze the image 222 pixel by pixel to detect instances of the part or object 406 in the image 222. For every instance detected, the processing circuit 214 is configured to apply a bounding box 408 to the image, a single bounding box being applied at each location where a candidate individual instance of the object 406 is identified by the machine learning model 218. In some embodiments, the processing circuit 214 is then configured to determine the first estimated count 410 by counting the number of bounding boxes 408 applied to the image. The bounding boxes being applied is shown in first stage image 404.

This first estimated count 410 may have some error associated therewith. For example, there may be instances where a bounding box 408 is drawn around two objects 406 because the machine learning model 218 identified a single object, when in reality, there were two or more. The first stage image 404 in FIG. 4 illustrates a few examples of this. As such, the first stage provides an estimated count with a possible error of Δ. That is, the actual count of the number of objects 406 can be written as the following equation:

$$\sum = {E}_{1} \text{+/-} Δ \qquad Equation 1$$

where Σ is the actual count of the number of objects 406, E₁ is the first estimated count 410 from the stage one 310, and Δ is some error. Stage two described below provides several techniques for minimizing the error, Δ, such that the estimated count, E, is either exactly equal to Σ or as close as possible.

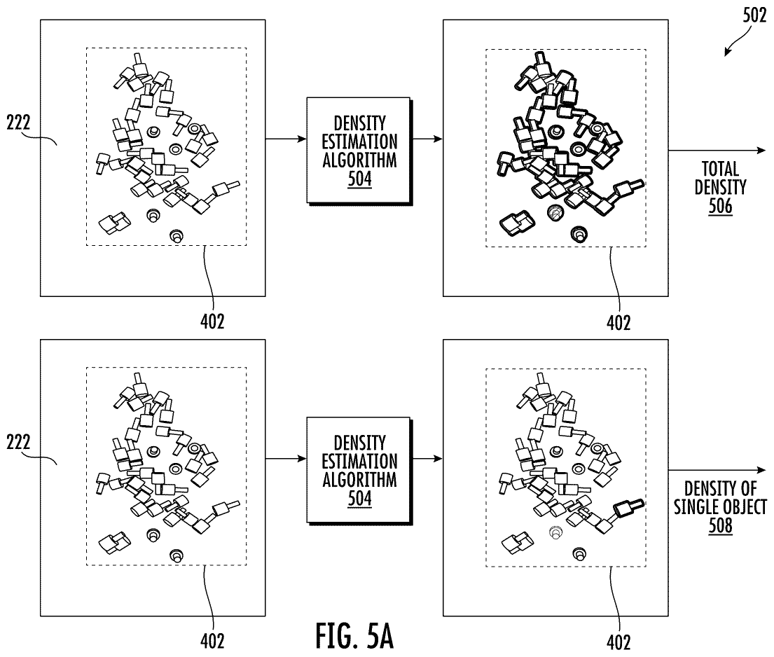

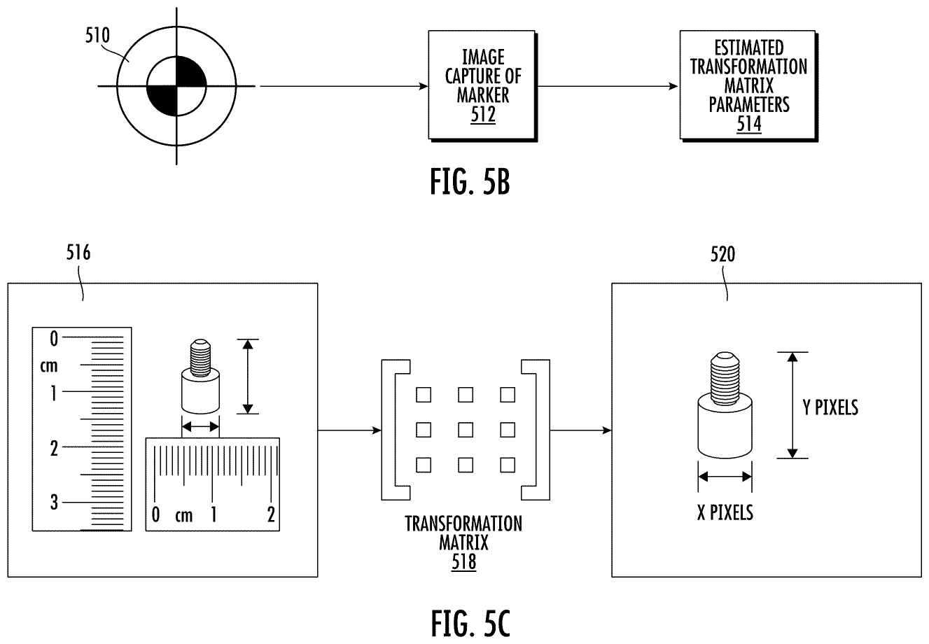

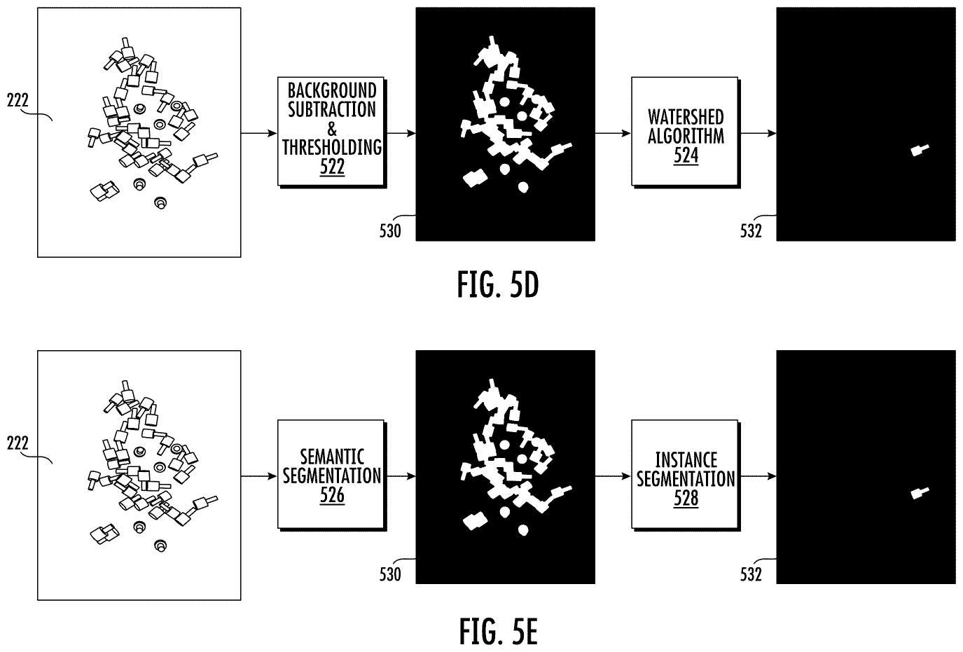

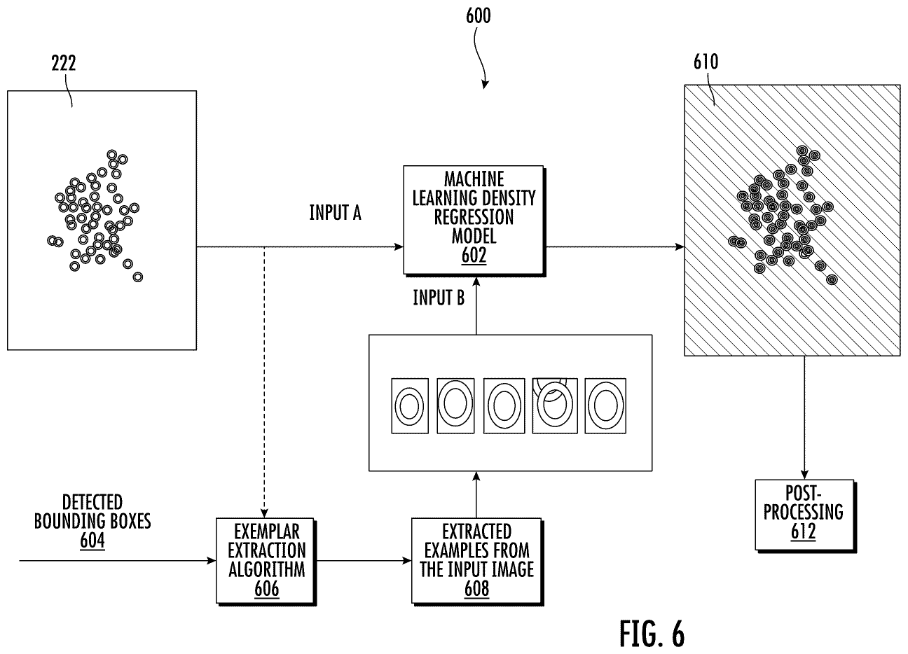

FIG. 5A illustrates an example implementation of stage two 312 of the multi-stage vision technique for analyzing images of objects according to some embodiments of the present disclosure. FIG. 5A provides a high-level example of density estimation 502 and FIGS. 5B-5E and FIG. 6 illustrate more specific implementations of density estimation algorithms. The type of density estimation algorithm that is used can be chosen based on the type of objects in the image 222 that are being counted. For example, the density estimation algorithm described in FIGS. 5B-5E may be used for bolts, screws, nails, and the like, whereas the algorithm described in FIG. 6 may be used for washers, O-rings, nuts, and the like. However, the techniques are not so limited. Instead, the algorithms described herein can be used for any objects being counted in the image 222.

As shown in FIG. 5A, the image 222 is further processed by applying a density estimation algorithm 504. In some embodiments, the processing circuit 214 is caused to determine the object density of the region of interest 402. To accomplish this, the processing circuit 214 is configured to identify the plurality of objects in a foreground of the image and determine a total density 506 of the plurality of objects in the foreground of the image. Then the processing circuit 214 is configured to identify a single object of the plurality of objects in the image 222 and determine a density of the single object 508. Next, the processing circuit 214 is configured to divide the total density 506 of the plurality of objects by the density of the single object 508 to obtain the object density of the region of interest 402. Again, FIGS. 5B-5E and FIG. 6 provide specific examples on how to calculate the total density and how to identify a single object and determine its density.

Next, the processing circuit 214 is configured to adjust the first estimated count 410 calculated above by taking into the density estimations described below. This adjustment includes the processing circuit 214 being configured to modify the plurality of bounding boxes such that the number of bounding boxes corresponds to a number of objects implied by the object density of the region of interest. Then, the processing circuit 214 will recount the plurality of bounding boxes to obtain the final count of the plurality of objects.

FIGS. 5B-5E illustrate example methods for determining the density estimation 502 based on dimensions of the objects, whereas FIG. 6 illustrates an example for determining the density estimation 502 using density regression.

In FIGS. 5B-5E, the dimension of a single instance of an object is determined first, including the dimensions in the real-world (e.g., the actual physical dimension of the object) and the dimensions of the object in the context of the camera coordinate systems. For example, as shown in FIG. 5B, the image 222 may include predefined markers, such as a ruler or other makers, that are physical markers in the image along with the physical objects. These markers will help determine the real-world dimensions of the object. The image is captured by the image capture device 108, and the captured image includes image capture of marker 512. Additionally, estimated transformation matrix parameters 514 are determined by the processing circuit 214. The transformation matrix is a matrix used to transform the dimensions of the object from real-world dimensions (e.g., actual length, actual width, etc.) to dimensions in the camera coordinate system (e.g., pixels). The estimated transformation matrix parameters 514 are parameters that help translate the real-world dimensions into the camera coordinate system and provide a number of pixels that the actual length of the object is translated to.

For example, the object in the physical world may be a rectangle with physical dimensions of 10 mm×12 mm. This may translate to 10 pixels×12 pixels in the camera coordinate system, or any other suitable dimension. The estimated transformation matrix parameters 514 help determine this conversion or transformation. For example, the transformation matrix 518 may indicate, for example, that an object with physical dimensions of 10 mm×12 mm may be transformed into the camera coordinate system into 10 pixels×12 pixels.

As shown in FIG. 5C, the object dimensions in the real-world 516 are determined by the processing circuit 214 and then the processing circuit 214 applies the transformation matrix 518 to the dimension of a single object to determine the dimensions of the object in the object dimension in camera coordinate system 520. This is used to determine a density of a single object. Similar techniques are used to determine the dimensions of all of the objects in the foreground of the image 222 to determine a total density of the objects in the image.

FIG. 5D provides one option (referred to as Option A) for determining the total density of the objects in the foreground of the image 222 and single object density. In some embodiments, the processing circuit 214 is configured to receive the image and dimension parameters, including the object dimension in camera coordinate system 520 from FIG. 5C. The image 222 and object dimension in camera coordinate system 520 are then processed by the processing circuit 214 for background subtraction & thresholding 522. The background of the image 222 is subtracted and pixel intensity thresholds are determined. These pixel intensity thresholds are determined to identify which pixels indicate that a portion of an object is being depicted by the pixel. Since the background of the image has been subtracted, it is now black in the image shown in FIG. 5D.

A foreground object mask 530 is then applied to the image. The foreground objects appear as white and the intensity of the pixels depicting those objects are measured. This helps determine all of the pixels that include a portion of an object. The total density of all of the objects is determined by the processing circuit 214 inspecting the pixels and their intensities. The total density of the objects, referred to as D_{FA}, is determined by the processing circuit 214 by inspecting the pixels and determining all pixels that indicate presence of an object.

Next, the processing circuit 214 is configured to apply a watershed algorithm 524 to the image with the background removed. The watershed algorithm 524 isolates a single object in the image. Moreover, a single instance mask 532 is applied and the density of the single object, referred to as D_{IA}, is determined based on the dimensions using the object dimension in camera coordinate system 520. Any suitable watershed algorithm, now known or developed in the future, can be used. The processing circuit 214 then determines a second estimate, referred to as E_{2A}, of the number of objects in the image 222 by dividing D_{FA} by D_{IA}.

$${E}_{2 A} = {D}_{FA} / {D}_{IA} \qquad Equation 2 A$$

Once the second estimate of the number of objects is determined, the processing circuit 214 is configured to modify the plurality of bounding boxes such that the number of bounding boxes corresponds to a number of objects, e.g., E_{2A}, implied by the object density of the region of interest. Then, the processing circuit 214 will recount the plurality of bounding boxes to obtain the final count of the plurality of objects. That is, E₁ provides a rough estimate of the count, which is corrected by the output of E_{2A} or E_{2B} described below. In some cases, the output of E₁ will be equal to the actual number of objects in the image. E_{2A} or E_{2B} will then be used just to cross-check E₁.

FIG. 5E provides a second option (referred to as Option B) for determining the total density of the objects in the foreground of the image 222 and a single object density. In some embodiments, the processing circuit 214 is configured to receive the image and dimensions, including the object dimension in camera coordinate system 520 from FIG. 5C. The image 222 and object dimension in camera coordinate system 520 are then processed using a semantic segmentation 526 machine learning model.

The semantic segmentation 526 can be performed by another deep learning-based technique that uses a machine learning model that has been trained using public data to segment the image 222. The deep learning model used for Option B can be designed for semantic segmentation that is employed to differentiate between foreground and background. This process includes applying a foreground object mask 530 to help identify the pixels that indicate presence of an object in the image. In semantic segmentation, the model performs per pixel classification and labels each of them as either foreground (e.g., white pixels in FIG. 5E) and background (e.g., black pixels). Then using the foreground object's mask and the bounding boxes obtained in the process described in FIG. 4, each individual object instance will be segmented. Then, the value of D_{IA} will be calculated using a small number of detected object instances. Finally, the estimate E_{2A} will be calculated as defined in Equation 2A. The density of all the objects, referred to as D_{FB}, in the image is determined based on the semantic segmentation of the objects.

Next, the processing circuit 214 is configured to apply an instance segmentation 528 algorithm to the image to isolate a single object and a single instance mask 532 is applied to allow the processing circuit 214 to determine the density of the single isolated object. The instance segmentation 528 is performed using the bounding boxes that were generated in FIG. 4. A single instance mask 532 is then applied to the image and the density of the single isolated object, referred to as D_{IB}, is determined using the instance segmentation. The processing circuit 214 then determines a second estimate, E_{2B}, of the number of objects in the image 222 by dividing D_{FB} by D_{IB}.

$${E}_{2 B} = {D}_{FB} / {D}_{IB} \qquad Equation 2 B$$

Once the second estimate of the number of objects is determined, the processing circuit 214 is configured to modify the plurality of bounding boxes such that the number of bounding boxes corresponds to a number of objects, e.g., E_{2B}, implied by the object density of the region of interest. Then, the processing circuit 214 will recount the plurality of bounding boxes to obtain the final count of the plurality of objects. That is, E_{2B} is used to modify the output of E₁ to be closer to E_{2B}, unless the two are already equal.

FIG. 6 is a flow diagram illustrating another example density estimation algorithm 220 that can be applied to the image 222 to modify the estimate of the count of the objects to minimize the error, Δ, described above. More specifically, FIG. 6 illustrates an example density regression 600 flow diagram showing a third option (termed Option C) for determining an estimated count (e.g., E_{2C}) using a density regression algorithm.

In this example embodiment, a different image 222 is used, specifically an image of O-ring objects. The image 222 is provided as INPUT A into a machine learning density regression model 602. This machine learning model can also be a deep learning model trained using public datasets to identify objects in an image using density regression. The density regression method can be termed as a method that involves predicting a density map for a given query image. This density map indicates the presence of objects of interest across the image. Each pixel in the density map represents the likelihood of an object being present at that location. An example of the query images is shown as INPUT B in FIG. 6. Using the query (exemplar) images, correlation of each query image with the objects is obtained in the input image. Wherever, there is a good match of the query image with object in the image (e.g., a probability higher than a predetermined threshold that an object is present in the image at a given pixel), there will be a high activation score generated. This process is repeated for all the query images and the input image and a density map 610 is generated. This density map 610 gives the likelihood of a presence of an object in the image. Some of the advantages of these methods include the fact that the density prediction module is category-agnostic. That is, no category or class label of the object is required. Moreover, another advantage is that the deep-learning model used in this process can be easily trained with a few shot learning technique. Another advantage of this technique is better accuracy compared to bounding-box object detection method.

In this case, the detected bounding boxes 604 from above are provided as input into an exemplar extraction algorithm 606, which also receives the image 222. The exemplar extraction algorithm 606 then extracts individual instances of the objects from the image 222. Extracted examples from the input image 608 are then provided as INPUT B into the machine learning density regression model 602. The processing circuit 214 then uses the machine learning density regression model 602 to determine a second estimate of the number of objects in the image using density regression and the extracted examples from the input image 608. Any suitable density regression method, either now known or later discovered can be used to perform the density regression process described herein.

Before the second estimate, E_{2C}, of the count is determined, the density map 610 is subject to post-processing. The post-processing setup is used to get the object count from the heatmap obtained from the deep learning model. In FIG. 6, the density map 610 represents the heatmap overlayed over the input image. The hatched region represents the background while the circles represent a heatmap. The centers of the circles are darker, indicating that the model is more confident, implying presence of an object at that location in the image. The post-processing setup involves quantifying the heatmap to obtain the object's count. Post-processing involves removing the noisy heatmap based on an empirically calculated threshold value. Pixels with values lower than the threshold are discarded as not indicating an object. The resulting heatmap image is passed on to a blob detection algorithm which provides the final object count, E_{2C}, based on the number of blobs detected by the blob detection algorithm.

After the second estimate, E_{2C}, of the number of objects is determined, again, the bounding boxes generated at FIG. 4 are modified by the processing circuit 214 to account for the density of the objects detected, per the second estimate, E_{2C}. The adjusted bounding boxes are then re-counted and the final count of the number of objects is output. As described above, the count of the number of objects is output to the workstation 104 or the user interface server 206, which then causes the user interface on the workstation 104 to be updated with the final count of the number of objects.

FIGS. 7A and 7B illustrate an example embodiment for scattering the objects in the image to improve the final count of the objects and reduce the error described above. As shown in FIG. 7A, the scatter image 700 shows how little scatter there is among the objects. More specifically, FIG. 7A shows that there is a large cluster 702 of objects with portions of objects touching other objects in a long continuous cluster of touching objects. Whereas 704 shows just two objects touching but spaced apart from the large cluster 702. Also 706 and 708 show individual objects separated from the large cluster 702 and the smaller cluster 704. Objects 706 and 708 demonstrate a large amount of scatter (e.g., very little touching if any at all) between themselves and the cluster 702, whereas the 702 shows very little scatter (e.g., a lot of touching of objects). In some cases, if the scatter of the objects is not sufficient, too many objects may be grouped together and mistaken as a single object. As such, it might be ideal to scatter the objects in the image more and retake the picture for analysis.

FIG. 7B illustrates the image capture environment 100 from FIG. 1 but includes a vibration device 710 added to the portable workbench 102. The vibration device 710 can be controlled by the workstation 104 or the image processing server 208. The vibration device 710 can be provided or located underneath or otherwise touching the tray 106 such that the tray can be vibrated thereby. The vibration from the vibration device 710 (e.g., a vibration motor, oscillator, or any other suitable device) is provided to increase the scatter of the objects in the tray 106. In some embodiments, when the image 222 is captured and first analyzed by the processing circuit 214, the processing circuit 214 is further caused to determine a measure of spread of the plurality of objects. The measure of spread can also be referred to as a measure of scatter among the objects. In some embodiments, the processing circuit 214 can assign the image a score indicating a measure of scatter or measure of spread.

The processing circuit 214 analyzes the image to determine a number of different clusters of objects, wherein a cluster is a number of contiguous and unbroken pixels. For example, if two objects are touching, side-by-side, pixels indicating a location of these objects in the image will show an unbroken continuous object without any separation (i.e., image background) between them. For example, element 704 shows two objects touching each other with no separation therebetween, whereas elements 706 and 708 show pixels indicating two objects with separation between themselves and the large cluster 702. In some embodiments, the processing circuit 214 is caused to assign a scatter score to the image based on the measure of spread or scatter among the objects.

The scatter score is a measure to estimate the separation between all the objects seen in the image. The lower value of scatter score (e.g. 0.1) indicates that a majority of objects are very close to each other forming a cluster. The number of clusters in the case will be fewer. In another scenario, when the scatter score is high (e.g. 0.98), this indicates that almost all the objects are well-separated from each other. Moreover, there is a high probability that the number of clusters is equal to the number of objects in the image. To calculate the scatter score, the pre-requisite is the object count. Using the foreground pixel mask (either obtained using the semantic segmentation technique or an image processing technique), the number of separate white blobs are counted. In some embodiments, a “connect-component” analysis is used to count the separate white blobs. After getting the separate white blob count, a ratio of the separate white block count with an object count is taken to obtain the scatter score. The ideal case value of scatter score is 1 when the number of objects counted is equal to a number of blobs (counted using connected-component analysis). For example, as shown in FIG. 7A, six (6) separate blobs are visible. However, the number of objects (parts) in the image is more. Therefore, the scatter score in this case will be closer to 0.1 than to 1.

In some embodiments, in response to the scatter score being below a threshold score, the processing circuit 214 of the image processing server 208 is configured to automatically send a control signal to the vibration device 710 to vibrate a container (e.g., the tray 106) holding the plurality of objects to increase the spread of the plurality of objects. In some embodiments, after the vibration device 710 has been turned off by a second control signal sent by the image processing server 208, an image is captured of the tray again and the operations described herein are repeated.

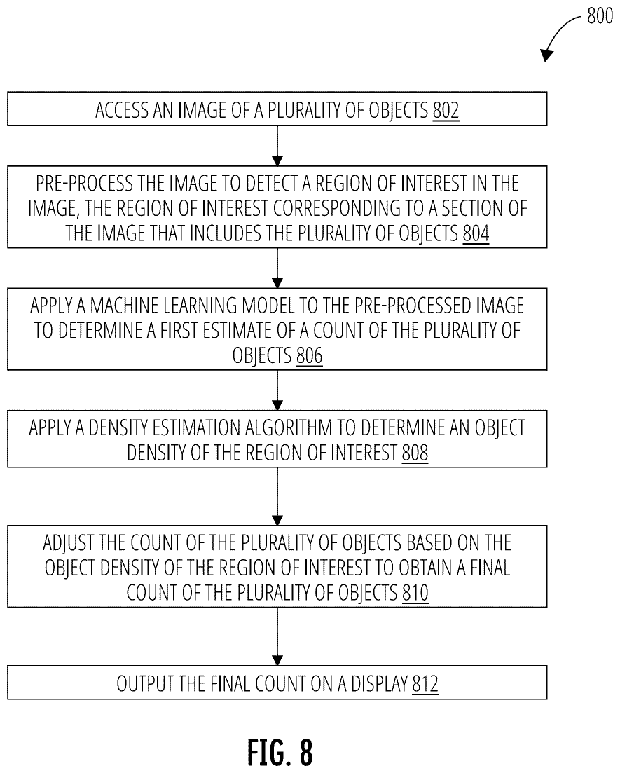

FIG. 8 is a flow chart illustrating example operations of a method 800 for multi-stage machine vision analysis of images of objects. As shown at block 802, in some embodiments, method 800 includes accessing an image of a plurality of objects. As shown at block 804, in some embodiments, method 800 includes pre-processing the image to detect a region of interest in the image, the region of interest corresponding to a section of the image that includes the plurality of objects. As shown at block 806, in some embodiments, method 800 includes applying a machine learning model to the pre-processed image to determine a first estimate of a count of the plurality of objects. As shown at block 808, in some embodiments, method 800 includes applying a density estimation algorithm to determine an object density of the region of interest. As shown at block 810, in some embodiments, method 800 includes adjusting the count of the plurality of objects based on the object density of the region of interest to obtain a final count of the plurality of objects. As shown at block 812, in some embodiments, method 800 includes outputting the final count on a display.

In some embodiments, the image of the plurality of objects includes a background color that is complimentary to a color of the plurality of objects. In some embodiments, pre-processing the image comprises reducing a size of the image and applying a noise removal algorithm to the image.

In some embodiments, detecting a region of interest in the image further comprises inspecting pixels of the image to determine which pixels of the image correspond to an object of the plurality of objects, and which pixels correspond to a background of the image, determining, based on inspection of the pixels, a perimeter of a location of the image within which the plurality of objects are located, and digitally drawing a border along the perimeter of the location, the border corresponding to the region of interest.

In some embodiments, the machine learning model is a trained deep learning model trained on a public dataset of various objects and the method includes using the trained deep learning model for identifying candidate individual instances of an object from the plurality of objects, applying a plurality of bounding boxes to the image, a single bounding box being applied at each location where a candidate individual instance of the object is identified by the deep learning model, and determining the first estimate of the count by counting the number of bounding boxes applied to the image.

In some embodiments, the density estimation algorithm includes determining the object density of the region of interest by identifying the plurality of objects in a foreground of the image, determining a total density of the plurality of objects in the foreground of the image, identifying a single object of the plurality of objects. In some embodiments, determining the object density of the region of interest further includes determining a density of the single object and dividing the total density of the plurality of objects by the density of the single object to obtain the object density of the region of interest.

In some embodiments, adjusting the count of the plurality of objects comprises modifying the plurality of bounding boxes such that the number of bounding boxes corresponds to a number of objects implied by the object density of the region of interest and recounting the plurality of bounding boxes to obtain the final count of the plurality of objects. In some embodiments, the method further comprises determining a measure of spread of the plurality of objects and assigning a scatter score to the image based on the measure of spread.

In some embodiments, the method further comprises, in response to the scatter score being below a threshold score, automatically sending a control signal to a vibration device to vibrate a container holding the plurality of objects to increase the spread of the plurality of objects.

Some embodiments of the disclosed system may be implemented, for example, using a storage medium, a computer-readable medium or an article of manufacture which may store an instruction or a set of instructions that, when executed by a machine (e.g., processor, processing circuit, or microcontroller), may cause the machine to perform a method and/or operations in accordance with embodiments of the disclosure. In addition, a server or database server may include machine readable media configured to store machine executable program instructions. Such a machine may include, for example, any suitable processing platform, computing platform, computing device, processing device, computing system, processing system, computer, processor, or the like, and may be implemented using any suitable combination of hardware, software, firmware, or a combination thereof and utilized in systems, subsystems, components, or sub-components thereof.

The various elements of the devices as previously described with reference to the figures above may include various hardware elements, software elements, or a combination of both. Examples of hardware elements may include devices, logic devices, components, processors, microprocessors, circuits, processors, circuit elements (e.g., transistors, resistors, capacitors, inductors, and so forth), integrated circuits, application specific integrated circuits (ASIC), programmable logic devices (PLD), digital signal processors (DSP), field programmable gate array (FPGA), memory units, logic gates, registers, semiconductor device, chips, microchips, chip sets, and so forth. Examples of software elements may include software components, programs, applications, computer programs, application programs, system programs, software development programs, machine programs, operating system software, middleware, firmware, software modules, routines, subroutines, functions, methods, procedures, software interfaces, application program interfaces (API), instruction sets, computing code, computer code, code segments, computer code segments, words, values, symbols, or any combination thereof. However, determining whether an embodiment is implemented using hardware elements and/or software elements may vary in accordance with any number of factors, such as desired computational rate, power levels, heat tolerances, processing cycle budget, input data rates, output data rates, memory resources, data bus speeds and other design or performance constraints, as desired for a given implementation.

One or more aspects of at least one embodiment may be implemented by representative instructions stored on a non-transitory machine-readable medium which represents various logic within the processor, which when read by a machine causes the machine to fabricate logic to perform the techniques described herein. Such representations, known as “IP cores,” may be stored on a tangible, machine readable medium and supplied to various customers or manufacturing facilities to load into the fabrication machines that make the logic or processor. Some embodiments may be implemented, for example, using a machine-readable medium or article which may store an instruction or a set of instructions that, if executed by a machine, may cause the machine to perform a method and/or operations in accordance with the embodiments. Such a machine may include, for example, any suitable processing platform, computing platform, computing device, processing device, computing system, processing system, computer, processor, or the like, and may be implemented using any suitable combination of hardware and/or software. The machine-readable medium or article may include, for example, any suitable type of memory unit, memory device, memory article, memory medium, storage device, storage article, storage medium and/or storage unit, for example, memory, removable or non-removable media, erasable or non-erasable media, writeable or re-writeable media, digital or analog media, hard disk, floppy disk, Compact Disk Read Only Memory (CD-ROM), Compact Disk Recordable (CD-R), Compact Disk Rewriteable (CD-RW), optical disk, magnetic media, magneto-optical media, removable memory cards or disks, various types of Digital Versatile Disk (DVD), a tape, a cassette, or the like. The instructions may include any suitable type of code, such as source code, compiled code, interpreted code, executable code, static code, dynamic code, encrypted code, and the like, implemented using any suitable high-level, low-level, object-oriented, visual, compiled and/or interpreted programming language.

As used herein, an element or operation recited in the singular and proceeded with the word “a” or “an” should be understood as not excluding plural elements or operations, unless such exclusion is explicitly recited. Furthermore, references to “one embodiment” of the present disclosure are not intended to be interpreted as excluding the existence of additional embodiments that also incorporate the recited features.

The present disclosure is not to be limited in scope by the specific embodiments described herein. Indeed, other various embodiments of and modifications to the present disclosure, in addition to those described herein, will be apparent to those of ordinary skill in the art from the foregoing description and accompanying drawings. Thus, such other embodiments and modifications are intended to fall within the scope of the present disclosure. Furthermore, although the present disclosure has been described herein in the context of a particular implementation in a particular environment for a particular purpose, those of ordinary skill in the art will recognize that its usefulness is not limited thereto and that the present disclosure may be beneficially implemented in any number of environments for any number of purposes. Accordingly, the claims set forth below should be construed in view of the full breadth and spirit of the present disclosure as described herein.

The foregoing description of example embodiments has been presented for the purposes of illustration and description. It is not intended to be exhaustive or to limit the present disclosure to the precise forms disclosed. Many modifications and variations are possible in light of this disclosure. It is intended that the scope of the present disclosure be limited not by this detailed description, but rather by the claims appended hereto. Future filed applications claiming priority to this application may claim the disclosed subject matter in a different manner and may generally include any set of one or more limitations as variously disclosed or otherwise demonstrated herein.

What is claimed is:

1. A computer implemented method comprising:
accessing an image of a plurality of objects;
pre-processing the image to detect a region of interest in the image, the region of interest corresponding to a section of the image that includes the plurality of objects;
applying a machine learning model to the pre-processed image to determine a first estimate of a count of the plurality of objects;
applying a density estimation algorithm to determine an object density of the region of interest;
adjusting the first estimate of the count of the plurality of objects based on the object density of the region of interest to obtain a final count of the plurality of objects; and
outputting the final count on a display.

2. The method of claim 1, wherein the image of the plurality of objects includes a background color that is complimentary to a color of the plurality of objects.

3. The method of claim 1, wherein pre-processing the image comprises:
reducing a size of the image; and
applying a noise removal algorithm to the image.

4. The method of claim 1, wherein detecting a region of interest in the image further comprises:
inspecting pixels of the image to determine which pixels of the image correspond to an object of the plurality of objects, and which pixels correspond to a background of the image;
determining, based on inspection of the pixels, a perimeter of a location of the image within which the plurality of objects are located; and
digitally drawing a border along the perimeter of the location, the border corresponding to the region of interest.

5. The method of claim 1, wherein the machine learning model is a trained deep learning model trained on a public dataset of various objects and the method includes using the trained deep learning model for:
identifying candidate individual instances of an object from the plurality of objects;
applying a plurality of bounding boxes to the image, a single bounding box being applied at each location where a candidate individual instance of the object is identified by the deep learning model; and
determining the first estimate of the count by counting the number of bounding boxes applied to the image.

6. The method of claim 5, wherein the density estimation algorithm includes determining the object density of the region of interest by:
identifying the plurality of objects in a foreground of the image;
determining a total density of the plurality of objects in the foreground of the image;
identifying a single object of the plurality of objects;
determining a density of the single object; and
dividing the total density of the plurality of objects by the density of the single object to obtain the object density of the region of interest.

7. The method of claim 6, wherein adjusting the first estimate of the count of the plurality of objects comprises:
modifying the plurality of bounding boxes such that the number of bounding boxes corresponds to a number of objects implied by the object density of the region of interest; and
recounting the plurality of bounding boxes to obtain the final count of the plurality of objects.

8. The method of claim 1, wherein the method further comprises:
determining a measure of spread of the plurality of objects; and
assigning a scatter score to the image based on the measure of spread.

9. The method of claim 8, wherein the method further comprises:
in response to the scatter score being below a threshold score, automatically sending a control signal to a vibration device to vibrate a container holding the plurality of objects to increase the spread of the plurality of objects.

10. A system comprising:
a processing circuit; and
a memory for storing executable instructions, which when executed by the processing circuit causes the processing circuit to:
access an image of a plurality of objects;
pre-process the image to detect a region of interest in the image, the region of interest corresponding to a section of the image that includes the plurality of objects;
apply a machine learning model to the pre-processed image to determine a first estimate of a count of the plurality of objects;
apply a density estimation algorithm to determine an object density of the region of interest;
adjust the first estimate of the count of the plurality of objects based on the object density of the region of interest to obtain a final count of the plurality of objects; and
output the final count on a display.

11. The system of claim 10, further comprising:
a mobile workbench;
a tray on the mobile workbench for holding the plurality of objects, the tray including a vibration device that is in electronic communication with the processing circuit and configured to vibrate the tray to increase a scatter of the plurality of objects;
a light source to illuminate the plurality of objects; and
an imaging device in communication with the processing circuit, wherein the imaging device is configured to capture the image of the plurality of objects and send the image to the processing circuit;
wherein the tray, and therefore the image of the plurality of objects, includes a matte background color that is complimentary to a color of the plurality of objects.

12. The system of claim 10, wherein the image of the plurality of objects includes a background color that is complimentary to a color of the plurality of objects.

13. The system of claim 10, wherein pre-processing the image includes the processing circuit being caused to:
reduce a size of the image; and
apply a noise removal algorithm to the image.

14. The system of claim 10, wherein detecting a region of interest in the image further includes the processing circuit being caused to:
inspect pixels of the image to determine which pixels of the image correspond to an object of the plurality of objects, and which pixels correspond to a background of the image;
determine, based on inspection of the pixels, a perimeter of a location of the image within which the plurality of objects are located; and
digitally draw a border along the perimeter of the location, the border corresponding to the region of interest.

15. The system of claim 10, wherein the machine learning model is a trained deep learning model trained on a public dataset of various objects and the processing circuit is further caused to use the trained deep learning model to:
identify candidate individual instances of an object from the plurality of objects;
apply a plurality of bounding boxes to the image, a single bounding box being applied at each location where a candidate individual instance of the object is identified by the deep learning model; and
determine the first estimate of the count by counting the number of bounding boxes applied to the image.

16. The system of claim 15, wherein applying the density estimation algorithm includes the processing circuit being caused to determine the object density of the region of interest, including the processing circuit being caused to:
identify the plurality of objects in a foreground of the image;
determine a total density of the plurality of objects in the foreground of the image;
identify a single object of the plurality of objects;
determine a density of the single object; and
divide the total density of the plurality of objects by the density of the single object to obtain the object density of the region of interest.

17. The system of claim 16, wherein adjusting the first estimate of the count of the plurality of objects includes the processing circuit being caused to:
modify the plurality of bounding boxes such that the number of bounding boxes corresponds to a number of objects implied by the object density of the region of interest; and
recount the plurality of bounding boxes to obtain the final count of the plurality of objects.

18. The system of claim 10, wherein the processing circuit is further caused to:
determine a measure of spread of the plurality of objects; and
assign a scatter score to the image based on the measure of spread.

19. The system of claim 18, wherein the processing circuit is further caused to:
in response to the scatter score being below a threshold score, automatically send a control signal to a vibration device to vibrate a container holding the plurality of objects to increase the spread of the plurality of objects.

20. A non-transitory computer-readable medium having executable instructions stored thereon, which when executed by a processing circuit, cause the processing circuit to:
access an image of a plurality of objects;
pre-process the image to detect a region of interest in the image, the region of interest corresponding to a section of the image that includes the plurality of objects;
apply a machine learning model to the pre-processed image to determine a first estimate of a count of the plurality of objects;
apply a density estimation algorithm to determine an object density of the region of interest;
adjust the first estimate of the count of the plurality of objects based on the object density of the region of interest to obtain a final count of the plurality of objects; and
output the final count on a display.
